(19) United States
(12) Patent Application Publication
(10) Pub. No.: US 2017/0153866 A1
(43) Pub. Date: Jun. 1, 2017

(54) Audiovisual Surround Augmented Reality (ASAR)

(71) Applicants: Daniel Grinberg, Gan-Haim (IL); Anat Kahane, Tel-Aviv (IL); Ori PORAT, Gan-Sorek (IL); Moran Cohen, Petach Tikva (IL)

(72) Inventors: Daniel Grinberg, Gan-Haim (IL); Anat Kahane, Tel-Aviv (IL); Ori PORAT, Gan-Sorek (IL); Moran Cohen, Petach Tikva (IL)

(73) Assignee: IMAGINE MOBILE AUGMENTED REALITY LTD., Rosh Haayin (IL)

(21) Appl. No.: 15/323,417

(22) PCT Filed: Jul. 3, 2014
(86) PCT No.: PCT/IL14/50598

§ 371 Date: Jan. 1, 2017

(51) Int. Cl. G06F 3/16; H04R 1/04; G02B 27/01; G06F 3/01

(52) U.S. Cl. CPC G06F 3/165; G06F 3/012; H04R 1/04; G02B 27/0172; H04R 2499/15; G02B 2027/0187; G02B 2027/014; G02B 2027/0138

(57) ABSTRACT

A system and method to enable realistic augmented reality 2D or 3D audiovisual imagery, integrating virtual object(s) and audio source data in the vicinity of a user/wearer of a head-mounted device (HMD), the HMD integrated with a mobile communication device. The system includes a HMD to facilitate enhancement of the user/wearer's audiovisual capabilities, a mobile communication device integrated with the HMD. The system also includes a dedicated system mounted on the HMD and comprising at least an embedded software solution, at least four (4) miniature speakers mounted on the HMD and configured to optimize the audio provided to the user/wearer and an inertial measurement unit (IMU) mounted on the HMD for processing the data on and through the speakers according to the data imputed to the software instructions, thereby providing realistic sound in the HMD and anchoring of sounds deriving from virtual objects in the real world.

### FIELD OF THE INVENTION

The present invention relates generally to augmented reality, and in particular to enabling the sound provided to a user/listener to be anchored to one or more specific objects/images.

### BACKGROUND OF THE INVENTION

An optical head-mounted display (hereinafter HMD) is a wearable computer intended to provide a mass-market ubiquitous computer. HMD's display information in a smartphone-like hands-free format, enabling communication, for example over the Internet via natural language voice commands.

Prior art sound technology is characterized by a listener location where the audio effects on the listener work best, and presents a fixed or forward perspective of the sound field to the listener. This presentation enhances the perception of a sound's location. The ability to pinpoint the optimal location of a sound is achieved by using multiple discrete audio channels routed to an array of speakers.

Though cinema and soundtracks represent the major uses of surround techniques, the scope of application of surround techniques is broader than only cinema and soundtrack environments, permitting creation of an audio-environment for many purposes. Multichannel audio techniques may be used to reproduce contents as varied as music, speech, natural or synthetic sounds for cinema, television, broadcasting or computers. The narrative space is also content that can be enhanced through multichannel techniques. This applies mainly to cinema narratives, for example the speech of the characters of a film, but may also be applied to plays for theater, a conference, or to integrate voice-based comments in an archeological site or monument. For example, an exhibition may be enhanced with topical ambient sound of water, birds, train or machine noise. Topical natural sounds may also be used in educational applications. Other fields of application include video game consoles, personal computers and other platforms. In such applications, the content would typically be synthetic noise produced by the computer device in interaction with its user.

It would be advantageous to provide a solution that overcomes the limited applicability of augmented reality systems known in the art and to enable more realistic and resourceful integration of virtual and real audio elements in the user's or listener's environment.

### SUMMARY OF THE INVENTION

Accordingly, it is a principal object of the present invention to enable the sound provided to a user/listener to be anchored to one or more specific objects/images while the object(s)/image(s) are fixed to one or more specific position(s), and to adapt the sound experience to change according to any changes in the specific position(s).

It is one other principal object of the present invention to enable more realistic and resourceful integration of virtual and real audio elements in the vicinity of a user/observer.

It is another principal object of the present invention to provide a system and method to create realistic augmented reality scenes using for example a set of head-mounted devices (HMD's).

It is further another principal object of the present invention to provide anchoring of sounds deriving from virtual objects in the real world by using HMD's for processing the sound on and through speakers mounted, for example on the HMD according to data imputed to software or hardware from a head-mounted inertial motion unit (IMU).

A system is disclosed for providing one or more object(s) or image(s) and audio source data to a user. The system includes: a head-mounted device (HMD) to facilitate enhancement of the user; audiovisual capabilities, the HMD comprising: a software module for processing data received from said object; one or more speakers configured to optimize the audio provided to the user; and an inertial measurement unit (IMU) for processing audiovisual data received from the object on and through the speakers according to kinetic data imputed to the software, enabling a sound provided to the user to be anchored to said objects/images while the object(s)/image(s) are fixed to (a) specific position(s), and to adapt the sound experience to changes in a specific position(s).

A computerized method is disclosed for enabling realistic augmented reality of audiovisual imagery, integrating virtual object(s) or image(s) and audio source data to a user by a head-mounted device (HMD), the method includes: distributing one or more speakers along a frame of the HMD; providing virtual sound to each speaker device by a head tracker or a inertial measurement unit (IMU) device; and projecting the volume of the sound(s) and the direction of the sound(s) by each speaker device according to a distance and angle, respectively of the user to the object(s).

According to an aspect of some embodiments of the present invention there is provided a system and method to enable realistic sound to be delivered to a frame of a head-mounted device, e.g. utilizing specially designed glasses. For example, a viewer or listener will hear the source of a sound linked to the source of an image. In an exemplary embodiment of the invention there are at least four, and preferably as many as twelve miniature speakers mounted in the frame of the HMD connected for example to the IMU.

According to another aspect of the invention there is provided a computerized method of processing sound data received for conversion to sound transmission by speakers mounted, for example on the frame of the HMD, including frequency and volume, and creating a realistic audio scenario responsive to the positioning of a virtual object or objects in the real world, and according to the user's head movement as measured by an IMU. The computerized method is further configured to create audio markers of the virtual objects in the real world using the IMU, and define in real time the relative positioning of the user/listener compared to the audio virtual object's markers, such as a virtual display screen positioned at a specific location on a wall.

According to another aspect of the invention there is provided a computerized method for processing an audio wave in a speakers system mounted on the HMD according to a defined relative positioning between the user and a virtual object.

In other words the present invention provides an embodiment which fixes the audio coming from a virtual image (i.e. the same way that a viewer/listener may fix the visual virtual image). For example if the viewer/listener is watching a 3D movie, and the source of the image is coming from a certain direction, so if the viewer/listener turns his head, the source will appear to move in the opposite direction relative to his head movement, and the source of the audio will move correspondingly.

There is provided according to one embodiment of the invention a virtual image, such as a virtual person talking to the viewer/listener, for example, or walking around him, where the virtual image and sound are identical to real image and sound. So if for example the virtual image walks behind the viewer/listener, he will still be heard even when not seen as the position of the virtual image will be known from the apparent direction of the sound. The “virtual reality” of the sound is determined by the strength of the sound as received by one or more speakers distributed around a frame of the HMD (i.e. glasses) and the sound is tracked by a head tracker. The speakers are distributed appropriately around the HMD/glasses so one can receive the sound from different angles. One of the unique features of the present invention is that it provides synchronization by the head tracker between the audio and the image. Therefore if the HMD user head is turned to the right an originally centered virtual image appears in the left frame and one's head is turned to the left an originally centered virtual image appears in the right frame. The same thing happens with the apparent direction of the sound from the virtual image. In other words the present invention provides a method and system that may anchors the sound to the image and creates a comprehensive integrated audio/visual impact.

According to some embodiments there is provided a method and device comprising more than one audio source, for example two virtual images may be talking to the viewer/listener simultaneously from different directions.

According to some embodiments there is provided a method and device for anchoring the sound to an image and creating a comprehensive, integrated audio/visual impact.

According to some other embodiments, there is provided a system for providing to a user audio source data associated with an object. The system has a head-mounted device (HMD) that includes: a software module; one or more speakers configured to provide sound associated with the object; and an inertial measurement unit (IMU) for providing kinetic data based on motion of the HMD, wherein the software module processes the audio source data and kinetic data to provide sound to the user as if the sound were anchored to said objects, the object being fixed to a specific position independent of the movement of the HMD.

According to still other embodiments, there is provided a computerized method for enabling realistic augmented reality. The method includes: distributing one or more speakers along a frame of a head mounted device (HMD); using an inertial measurement unit (IMU) to sense movement of the HMD; providing sound to the speakers; and using data from the IMU to adjust the volume of the sound from each speaker according to a distance and angle of a user of the HMD to a virtual object. The sounds of the speakers appear to originate from the virtual object.

As will be illustrated hereinafter, in the IMU head tracker device there are several axes: x, y and z. For example, if the viewer/listener is walking along on the x axis toward the image, the sound gets louder and the image appears larger. The present invention provides a method for anchoring the sound to a virtual object (and not necessarily an image). For example, if the object is a person and he walks behind the viewer/listener, he is no longer seen. Distributing the speakers along the frame, each speaker device projects the volume of the sound and the direction of the sound according to the distance and angle of the viewer/listener to the object.

The data comes to each speaker device from the head tracker/IMU device but the object doesn't really exist. It's all virtual information. For example, a virtual ball hitting the opponent's real racquet. The laws of physics are incorporated by the system to project the loudness of the sound and angle of the sound correctly at the time of impact.

The following terms are defined for clarity:

The term “hyper reality” refers to a combination of viewing and listing to real objects with virtual objects. For example, a real person could be standing next to a virtual person and they both may appear real. In another example, one can play a game of ping-pong with a friend located in another city. Both are wearing coordinated HMD/glasses, and both see a virtual table and virtual ball but each player has a real paddle in his hand, thus combining virtual and real objects in one scenario.

The term ‘Inertial motion Unit’ (IMU) refers to a unit configured to measure and reports on an object's velocity, orientation and gravitational forces, using a combination of accelerometers, gyroscopes and magnetometers.

The term ‘Digital Signal Processor’ (DSP) refers to a specialized microprocessor designed specifically for digital signal processing, generally in real-time computing.

The term ‘Open Multimedia Application Platform (OMAP)’ refers to the name of Texas Instrument's application processors. The processors, which are systems on a chip (SoC's), function much like a central processing unit (CPU) to provide laptop-like functionality for smartphones or tablets. OMAP processors consist of a processor core and is a group of Internet protocol (IP) modules. OMAP supports multimedia by providing hardware acceleration and interfacing with peripheral devices.

The term ‘Liquid Crystal on Silicon’ (LCoS) refers to a “micro-display” technology developed initially for projection televisions, but is now used also for structured illumination and Near-eye displays. The Liquid Crystal on Silicon (LCoS) is micro-display technology related to Liquid Crystal Display (LCD), where liquid crystal material has a twisted-nematic structure but is sealed directly to the surface of a silicon chip.

The term ‘Application-Specific Integrated Circuit’ (ASIC) refers to a chip designed for a particular application.

The term ‘Low-voltage differential signaling’ (LVDS) refers to a technical standard that specifies electrical characteristics of a differential, serial communication protocol. LVDS operates at low power and can run at very high speeds.

An object localization and tracking algorithm integrates audio and video based object localization results. For example, a face tracking algorithm and a microphone array are used to compute two single-modality speaker position estimates. These position estimates are then combined into a global position estimate using a decentralized Kalman filter. Experiments show that such an approach yields more robust results for audio-visual object tracking than either modality by itself.

The term ‘Kalman filter’ refers to an algorithm that uses a series of measurements observed over time, containing noise (i.e. random variations) and produces estimates of unknown variables that tend to be more precise than those based on a single measurement alone. More formally, the Kalman filter operates recursively on streams of noisy input data to produce a statistically optimal estimate of the underlying system state. The Kalman filter is a widely applied concept in time series analysis used in fields such as signal processing and for determining the precise location of a virtual object. Estimates are likely to be noisy; readings ‘jump around’ rapidly, though always remaining within a few centimeters of the real position.

The term ‘set-top box’ (STB) refers to an information appliance device that generally contains a TV-tuner input and displays output, by virtue of being connected to a television set and an external source of signal, turning the source signal into content in a form that can then be displayed on the television screen or other display device, such as the lenses of head-mounted glasses.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic block diagram of the main components and data flow of an audiovisual system constructed according to the principles of the present invention;

FIG. 2 is an illustration of an exemplary speaker layout along a glasses frame, constructed according to the principles of the present invention;

FIG. 3 is a series of illustrations of an exemplary virtual reality image projected onto the field of view of the wearer of the glasses, constructed according to the principles of the present invention; and

FIG. 4 is an illustrative sketch of a user/wearer's head used to describe principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

The present invention relates generally to augmented reality, and in particular to enable the sound provided to a user/listener to be anchored to one or more specific objects/images while the object(s)/image(s) are fixed to (a) specific position(s), and to adapt the sound experience to changes in the specific position(s).

According to prior art solutions the sound and image provided for example in the theater or home TV, where the viewer/listener is in his seat, remains typically in front of him. By contrast, the present invention provides a system and device including speakers that may be mounted around the periphery of the viewer/listener's head, such as in the frame of specially-designed glasses or head-mounted device. Speakers in a movie theater or in-home sound system place the speakers around the periphery of the theater hall or the home TV room. This is far different from having the speakers in the frame of glasses worn by the viewer.

The present invention provides a system and device including three features mounted together: three-dimensional (3D) viewing anchored viewing and anchored sound synchronized to the viewing, thus enabling true augmented reality to the user.

The present invention further provides a method for creating a 3D audio/visual scene surrounding the user, wherein the sound is perceived realistically on the plane of action (x and y axes), as well as up and down (the z-axis). Examples of such audio/visual scene may be:

A virtual snake in the room: the user can hear the snake from its location in the room, and perceive the snake's location, even if the user doesn't see the snake.

An erotic scene: a virtual woman dancing around the user and whispering in the user's ear from behind.

Virtual birds flying all around and chirping.

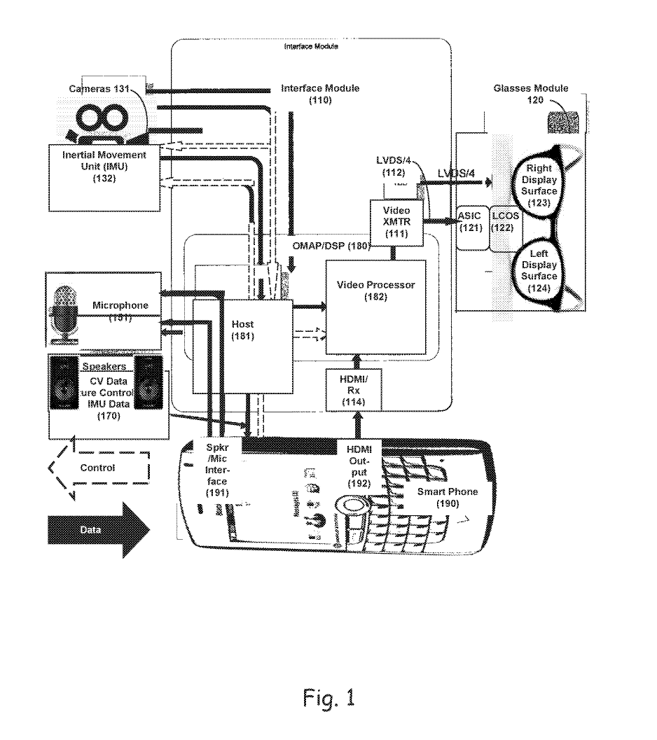

FIG. 1 is a schematic block diagram of an exemplary embodiment of the main components and data flow of an audiovisual system, constructed according to the principles of the present invention. The audiovisual system may include an Interface Module 110, which primarily acts as the interface between:

the glasses 120, worn by the viewer/listener as a multi-functional head-mounted device, typically housing at least; speakers 152; microphone(s) 151; and camera 131; and

a computer device such as a smart phone device 190 of the viewer/listener

Interface module 110 primary includes at least a host/controller 181; and video processor 182.

According to one embodiment of the invention the glasses 120 may include a High Definition Multimedia Interface™ (HDMI) output 192 of, for example the user's Smartphone 190, or other mobile device, which transmits both high-definition uncompressed video and multi-channel audio through wired or wireless connection. The system may be activated for example as follows; the process starts as the output 192 is received by HDMI/Rx 114 of the Interface Module 110. At the next step a video signal or data is further transmitted through the Video Processor 182 of the OMAP/DSP 180. Afterwards, the signal is transmitted from Video Processor 182 to the Video Transmitter 111 of Interface Module 110 to the ASIC 121 of the glasses module 120 according to the LVDS standard 112 and LCoS technology.

At the next step, LCoS 122 passes the video data to a right display surface 123 and a left display surface 124 for display. According to another embodiment of the invention the Smartphone 190, or other mobile or computing device, data may also be transmitted from the Speaker/Microphone Interface 191 through a Host 181 of Interface Module 110 to the Speakers 152 and Microphone 151, respectively. Microphone 151 enables the issuance of voice commands by the viewer/listener/speaker. Host 181 also receives data from the inertial motion unit (IMU) 132, and sends control signals to IMU 130, Camera 131 and Video Processor 182, and sends: computer vision (CV) data; Gesture Control data; and IMU data 170 to Smartphone 190.

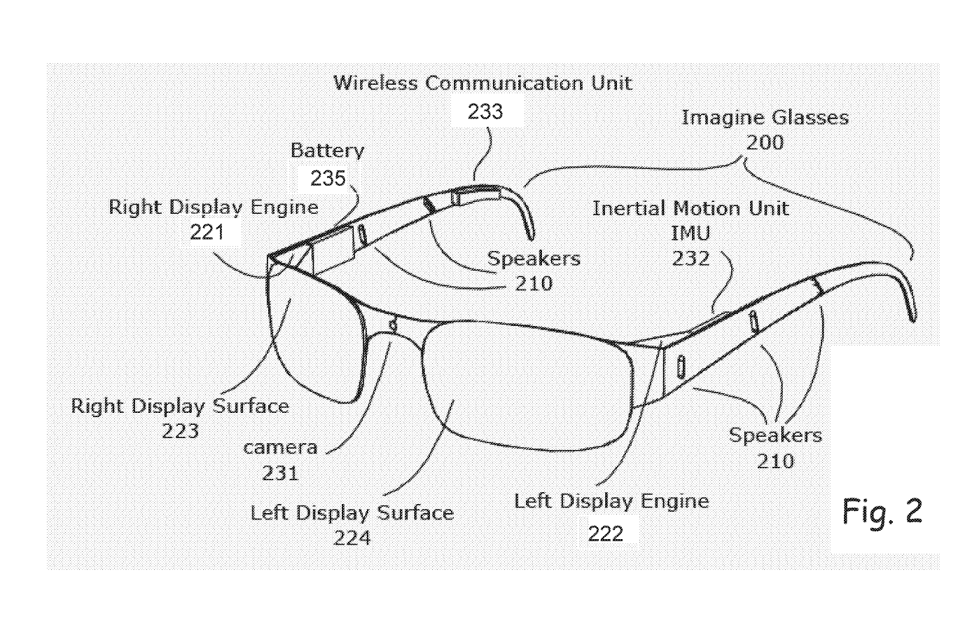

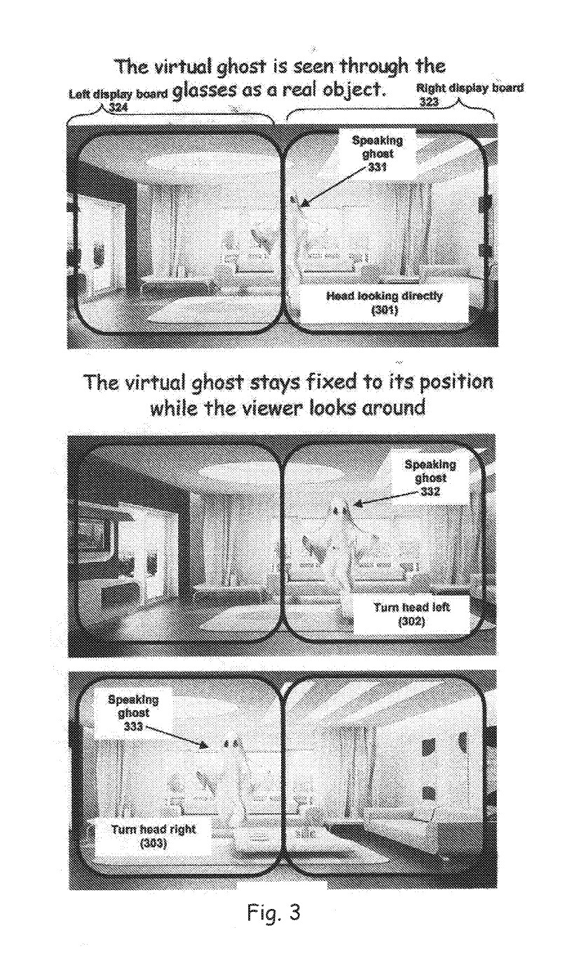

FIG. 2 is an illustration of an exemplary layout of speakers 210 along the frame of glasses 200, constructed according to the principles of the present invention. The glasses 200 may include a compact wireless communication unit 233, and a number of compact audio/visual components, located for example especially in close proximity to the ears, mouth and eyes of the viewer/listener. For example, the speakers 210 may be substantially evenly distributed around the frame of glasses 200, thereby enabling realistic virtual object-tracking, and corresponding sound projection. According to one embodiment of the invention glasses 200 may include six speakers 210, a 1320 mAh battery 225, a right display surface 223 and left display surface 224 to provide the virtual imagery. The glasses may further include a right display engine 221 and left display engine 222, respectively, as will be exemplified in FIG. 3.

Thus, what are otherwise normal glasses lenses become according to the present invention embodiments a screen on which images are projected, which generally appear to the viewer as virtual images on walls, ceiling, floor, free-standing or desktop, for example. Bystanders cannot see the virtual images, unless of course they also have the “glasses” of the present invention, and by prearrangement between the parties, such as by Facebook™ interaction. These virtual images may include desktop documents in all the formats one normally uses on a personal computer, as well as a “touch” curser and virtual keyboard.

The camera 231 records the visual surrounding information, which the system uses to recognize markers and symbols. Virtual imagery includes such applications as:
1. Internet browsing—IMU 232 with a set-top-box (stb)+Nintendo GameCube™

(GC) mouse and keyboard.
2. Interactive Games—scenario including independent objects game commands
3. Additional contents on items based on existing marker recognition apps+stb.
4. Simultaneous translation of what a user sees, picked up by camera(s) 231, for example, while driving in a foreign country—based on existing optical character recognition (OCR) apps+IMU stb.
5. Virtual painting pallet—IMU stb+commands+save.
6. Messaging—IMU stb+commands.
7. Calendars and alerts—IMU stb+commands.
8. Automatic average azimuth display—average.

FIG. 3 is a series of illustrations of an exemplary virtual reality image projected onto a field of view of a wearer of the glasses, such as glasses 200, constructed according to the principles of the present invention. As a person-hologram is projected the user can see the other person as a hologram. The hologram is not a real person; it is a virtual image, i.e., augmented reality. The virtual image may be positioned in the center of the field of vision of the viewer/listener and may be talking to the viewer/listener. If the viewer/listener looks to one side, the hologram will remain in the same position in the room and it will slide over from being in the central position of the field of view. This is the anchoring portion of the enablement of true augmented reality. Thus, when the viewer/listener turns his head the anchored image remains in its fixed place, unless of course, it is moving, as in the case of a ping pang ball during a game.

According to some embodiments of the invention, an object tracker may automatically perceive the exact position of the source of the sound, for example by well-known triangulation techniques known in the art for relative distance and angle for the several speakers in the frame. The present invention provides a virtual reality image and sound effect that may be balanced from speaker to speaker; vis-a-vis the position of the head. For example, as shown in FIG. 3, a user and a virtual person (a holographic character resembling a ghost) are face to face. As the virtual person is talking to the user, the sound provided by the virtual person is perceived in the front central speaker of the glasses, so the user hears it from the front central speaker.

Therefore, according to some embodiments of the invention there is provided a system and method which enables the positioning of the image coming to the user linked with the positioning of the sound. i.e., the sound is heard to come from the image, and moves with the image according to the image's distance from the user. In other words, the sound moves to one or more speakers in the side of the glasses frame, and therefore the sound source is anchored to the image source, thereby creating an integrated scenario of sight and sound, resulting in a realistic effect.

According to some embodiments of the invention, as an exemplary hologram in the form of a speaking person moves around, the audio and video received by the wearer/user will be heard and seen to emanate from the same source position. The present invention provides the perception that the hologram is moving synchronously in sight and sound because of predominant sound shifts from headset speaker to headset speaker in accordance with the movement. By contrast, according to the prior art solutions a hologram character will always look like and sound as if it is in the same place relative to the glasses lens, even if the viewer does not see the virtual person.

Additionally, the present invention differs from a movie theater sound system. In the movie theater the speakers are positioned in the periphery of the theater, whereas in the present invention the speakers are positioned around the frame of the glasses worn by the user. Also, in the theater the image always remains in front of the viewer, so the movie viewer hears the sounds as if he were in the picture. With the present invention one actually sees and hears virtual objects around oneself. As the users head rotates stationary virtual object(s) appear(s) to shift visually and audibly in the opposite direction. For example there may be several objects around the user and he may hear sound emanating from each of them.

As shown in FIG. 3, when the viewer's head is looking directly ahead 301, the virtual speaking ghost 331 is seen in the center of the field of vision through the glasses, left display board 324 and right display board 323, as a real object. When the viewer's head is turned to the left 302, the virtual speaking ghost 332 is seen in the right-hand display board 323 of the field of vision through the glasses. When the viewer's head is turned to the right 303, the virtual speaking ghost 333 is seen in the left display board 324 of the field of vision through the glasses. Analogously, the distribution of sound/sound volume amount the speakers 210 changes as the viewer rotates his head. That, a rotation to the left will increase the relative speaker volume of the right-side speakers 210, and a rotation to the right will increase the relative speaker volume of the left-side speakers 210.

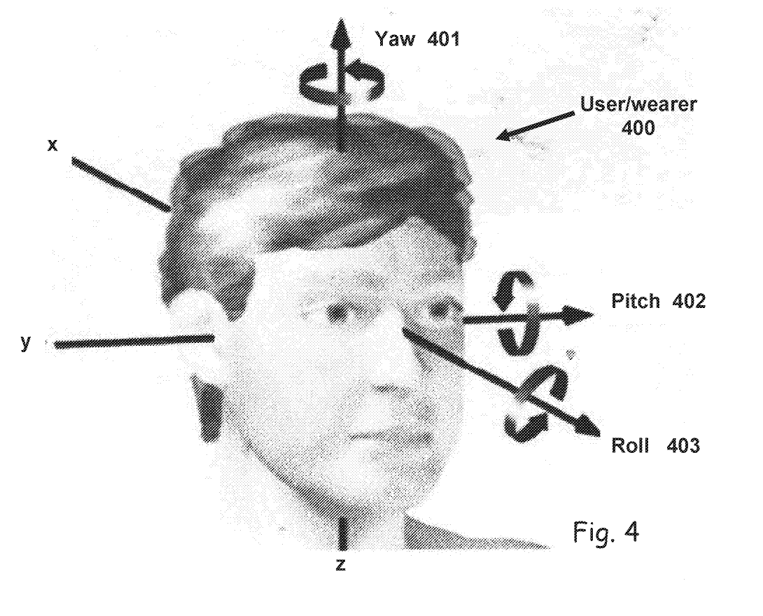

FIG. 4 is an illustrative sketch of the user/wearer's head 400, according to the principles of the present invention. Sound data received by the mounted speakers is processed by the interface module. The sound data includes at least frequency and volume. The processing of the sound data creates a realistic audio scene in reverse direction to and proportional to the user/wearer's head movements and positioning of a virtual object(s) in the real world relative to the user/wearer, according to the users angular head movement around an imaginary lengthwise axis, from head-to-toe (pitch) 402, as measured by the IMU. Yaw 401 and roll 403 of the user/wearer's head is compensated for in a similar way.

For example, moving images, such as the hologram shown in FIG. 3 may be seen with the glasses on and not by anyone else around the viewer as he's viewing. The actual technology is in the boxes on the outsides of the lenses, one for each temple: Lumus Optical Engine (OE)-32 modules project 720p resolution in 3D received through HDMI 114 of FIG. 1.

According to one embodiment, once calibrated and mounted in the frame or glasses, the user cannot physically rotate the OE32's anymore, or move the LCoS, but he can still move the image on the LCoS to correct residual errors in the line-of-sight alignment or, in this case the line-of-sound alignment.

This can be done by having an electronic scrolling mechanism in the electronics of right display engine 221 and left display engine 222 of FIG. 2. By setting dX and dY scrolling parameters to each of the right display surface 223 and left display surface 224 of FIG. 2, one can fine align the two settings. A scrolling of the image in one pixel in each direction is equivalent to a shift of 15 arc-minutes in the line-of-sight. The physical jig needed for this final alignment includes a set of two video cameras, or in this case two microphones, positioned in front of the frame, and a personal computer (PC) that will overlap the two video images (recordings) one on top of each other and display (playback) the misalignment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

We claim:

1. A system for providing to a user audio source data associated with an object, the system comprising:
a head-mounted device (HMD) including:
a software module:
one or more speakers configured to provide sound associated with the object; and
an inertial measurement unit (IMU) for providing kinetic data based on motion of the HMD,
wherein the software module processes the audio source data and kinetic data to provide sound to the user as if the sound were anchored to said objects, the object being fixed to a specific position independent of the movement of the HMD.

2. The system of claim 1, comprising a mobile communication device, said mobile device configured to be in communication with said HMD.

3. The system of claim 1 wherein said HMD is configured to provide a true augmented reality to the user.

4. The system claim 1, wherein said objects are virtual objects. The system of claim 4, wherein the virtual objects are selected from the group comprising:
a virtual image of a person;
a virtual ball;
a virtual ping-pong table;
a virtual screen; and
a virtual keyboard.

6. The system of claim 3, wherein the HMD is configured to provide the virtual object synchronously in sight and sound.

7. A computerized method for enabling realistic augmented reality, the method comprising:
distributing one or more speakers along a frame of a head mounted device (HMD);
using an inertial measurement unit (IMU) to sense movement of the HMD;
providing sound to the speakers; and:
using data from the IMU to adjust the volume of the sound from each speaker according to a distance and angle of a user of the HMD to a virtual object;
whereby the sounds of the speakers appear to originate from the virtual object.

8. The method of claim 7, further comprising adjusting the volume each speaker so that the sounds provided to the user are anchored to one or more specific objects/images fixed to (a) specific position(s) independent of the movement of the HMD.

9. The method of claim 8, further comprising:
creating a realistic audio scene in reverse direction to and proportional to the viewer/listener's head movements and positioning of a virtual object(s) in the real world relative to the user/wearer, according to the user's angular head movement around an imaginary lengthwise axis, from head-to-toe (yaw), as measured by the IMU;
compensating for the user's angular head movements around imaginary axes for pitch and roll, as measured by the IMU; and
establishing audio markers of the virtual objects in the real world using the IMU, and defining in real time the relative positioning of the user/wearer relative to the audio data and virtual object audio markers.

10. The method of claim 7 comprising enabling realistic augmented reality in 2D or 3D.

11. The method of claim 7 wherein the HMD is configured to facilitate enhancement of the user audiovisual capabilities.

12. The method of claim 7 comprising integrating a mobile communication device with the HMD.

13. The method of claim 7 wherein the speakers are configured to optimize the audio provided to the user/wearer.

14. The method of claim 7 comprising mounting the IMU on the HMD.

15. The method of claim 13 comprising processing the data on and through the speakers by the IMU according to data imputed to software instructions.

16. The method of claim 5, wherein the data is audio data.

17. The method of claim 16, wherein the audio data is voice data.

18. The method of claim 16, wherein the audio data is musical data.

19. The method of claim 15, wherein the data is audio and visual data.

20. The method of claim 19, wherein the visual data is data relating to real objects.
